(19) United States
(12) Patent Application Publication
(10) Pub. No.: US 2026/0285173 A1
(43) Pub. Date: Sep. 24, 2026

(54) CHARGING CONTROL APPARATUS OF ELECTRIC VEHICLE

(71) Applicant: SUBARU CORPORATION, Tokyo (JP)

(72) Inventor: Akifumi SUGAYA, Tokyo (JP)

(21) Appl. No.: 19/547,272

(22) Filed: Feb. 23, 2026

(30) Foreign Application Priority Data
Mar. 19, 2025 (JP) 2025-045526

(51) Int. Cl. B60L 53/10; B60L 53/14; B60L 53/20; B60L 53/62; B60L 53/68

(52) U.S. Cl. CPC B60L 53/11; B60L 53/14; B60L 53/20; B60L 53/62; B60L 53/68; B60L 2210/14; B60L 2240/547; B60L 2250/16; B60L 2260/162

(57) ABSTRACT

A charging control apparatus of an electric vehicle that includes a battery configured to store electric power for travel, a charging port configured to take in direct current power for charging from an external charging facility and a charging circuit configured to charge the battery with the direct current power taken in via the charging port includes an interface configured to exchange information with a user and a charging controller configured to control charging. The charging circuit includes a booster circuit configured to boost a voltage of the direct current power. When a charging end voltage of the battery is higher than a maximum voltage of the direct current power that the charging facility is capable of outputting, the charging controller allows the user to make a choice via the interface about whether to charge the battery at a boosted voltage boosted by the booster circuit.

### CROSS-REFERENCE TO RELATED APPLICATIONS

The present application claims priority from Japanese Patent Application No. 2025-045526 filed on Mar. 19, 2025, the entire contents of which are hereby incorporated by reference.

### BACKGROUND

The disclosure relates to a charging control apparatus of an electric vehicle.

A technology of transmitting direct current (DC) power output from a charging facility to a battery of an electric vehicle to rapidly charge the battery has been put to practical use. In recent years, a battery installed in an electric vehicle has become diverse in voltage and higher in voltage. As a result, there are cases where the maximum voltage of DC power that a charging facility can output is below the charging voltage of a battery.

Japanese Unexamined Patent Application Publication No. 2019-047677 discloses an electric vehicle that can switch how to charge a battery between charging the battery at a voltage boosted via a booster circuit and charging the battery at a voltage not via the booster circuit, according to the maximum voltage of the DC power that the charging facility can output.

### SUMMARY

An aspect of the disclosure provides a charging control apparatus of an electric vehicle that includes a battery configured to store electric power for travel, a charging port configured to take in direct current power for charging from an external charging facility, and a charging circuit configured to charge the battery with the direct current power taken in via the charging port, the charging control apparatus including:
an interface configured to exchange information with a user; and
a charging controller configured to control charging,
wherein the charging circuit comprises a booster circuit configured to boost a voltage of the direct current power, and
wherein when a charging end voltage of the battery is higher than a maximum voltage of the direct current power that the charging facility is capable of outputting, the charging controller allows the user to make a choice via the interface about whether to charge the battery at a boosted voltage boosted by the booster circuit.

### BRIEF DESCRIPTION OF THE DRAWINGS

FIG. 1 is a block diagram illustrating an electric vehicle provided with a charging control apparatus of an embodiment(s) of the disclosure.

FIG. 2 is a circuit diagram illustrating an example of a charging circuit.

FIG. 3 is a flowchart illustrating a procedure for a charging control process of a first embodiment, the charging control process being performed by a charging controller.

FIG. 4 is a graph of a first example illustrating a relationship between a voltage of DC power that a charging facility can output and a charging voltage of a battery.

FIG. 5 is a graph of a second example illustrating a relationship between a voltage of DC power that a charging facility can output and the charging voltage of the battery.

FIG. 6 is a flowchart illustrating a procedure for a charging control process of a second embodiment, the charging control process being performed by the charging controller.

### DETAILED DESCRIPTION

Charging accompanying voltage boosting with a booster circuit causes power loss at the time of voltage conversion. Accordingly, the charging efficiency decreases, and the charging time increases. Many recent charging facilities charge fees according to the charging time. In this case, if charging via a booster circuit is performed, the fee for the amount of charging power is high. On the other hand, if rapid charging is desired, charging with a booster circuit may be useful.

It is desirable to provide a charging control apparatus of an electric vehicle, the charging control apparatus being capable of performing charging in various situations with suitable manners therefor.

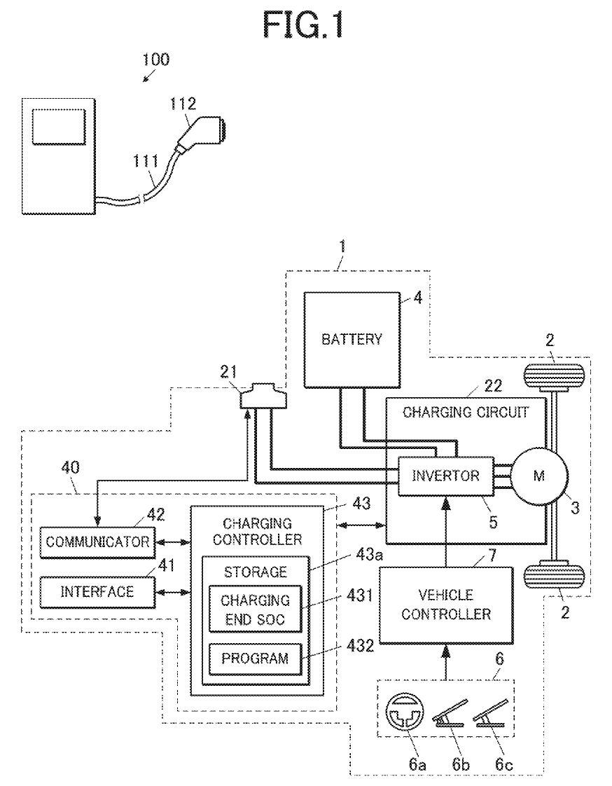

Hereinafter, one or more embodiments of the disclosure will be described in detail with reference to the drawings. FIG. 1 is a block diagram illustrating an electric vehicle 1 provided with a charging control apparatus 40 of an embodiment(s) of the disclosure.

The electric vehicle 1 includes drive wheels 2, an electric motor 3 that drives the drive wheels 2, a battery 4 that stores electric power for travel, an inverter 5 that converts electric power between the electric motor 3 and the battery 4, and an operation unit 6 that is operated by a driver who drives the electric vehicle 1. The electric vehicle 1 further includes a vehicle controller 7 that controls the inverter 5 by receiving signals from the operation unit 6, a charging port 21 that can take in DC power from an external charging facility 100, and a charging circuit 22 that charges the battery 4 by transmitting the taken-in DC power thereto. The electric vehicle 1 still further includes an interface 41 that can exchange information with a user, a communicator 42 that communicates with the charging facility 100 coupled thereto via the charging port 21, and a charging controller 43 that controls charging. Of these, the interface 41 and the charging controller 43 are included in the charging control apparatus 40 of this embodiment.

The vehicle controller 7 is an electronic control unit (ECU) and drives the inverter 5 to cause the electric motor 3 to perform power running or regenerative operation on the basis of operation signals from the operation unit 6. This realizes acceleration and deceleration of the electric vehicle 1 in response to driving operations. The operation unit 6 includes a steering member 6a, such as a steering wheel, a brake member 6b, such as a braking pedal, and an acceleration member 6c, such as an accelerator pedal. The operation unit 6 is not limited to being configured to be operated by the driver, but may be configured to be operated by a self-driving system.

The battery 4 is, for example, a lithium-ion rechargeable battery that outputs a high voltage, such as 200 V, 400 V or 800 V, or a nickel-metal hydride rechargeable battery, but various other types of rechargeable battery may be used. The battery 4 has a property that the lower the state of charge (SOC), the lower the charging voltage.

The charging facility 100 has a cable 111 that transmits DC power and a charging connector 112 that can be coupled to the charging port 21 of the electric vehicle 1. The charging connector 112 is, for example, a so-called charging gun. The charging facility 100 can supply DC power to the electric vehicle 1 via the cable 111 and the charging connector 112. The charging facility 100 can adjust the voltage of the DC power within a range up to the maximum voltage Vmax.

The charging port 21 is a connector to which the charging connector 112 of the charging facility 100 can be coupled. The cable 111 includes a signal line for communication, and the charging port 21 and the charging connector 112 include connection terminals for communication. Via the signal line and the communicator 42, the charging controller 43 and the charging facility 100 are communicable with one another.

The charging controller 43 can exchange, with the charging facility 100 via the communicator 42, control information on the start and the end of charging, control information during charging, and control information on charging specifications.

The charging facility 100 is located at one of various locations. Charging facilities 100 located at various locations include charging facilities 100 with a high maximum voltage Vmax of DC power that the charging facilities 100 can output, and charging facilities 100 with a low maximum voltage Vmax of DC power that the charging facilities 100 can output.

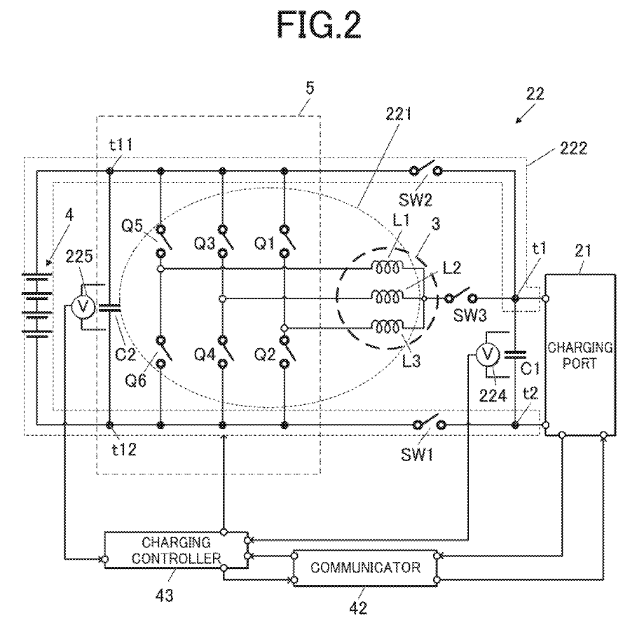

FIG. 2 is a circuit diagram illustrating an example of the charging circuit 22. The charging circuit 22 includes a booster circuit 221, a pass-through circuit 222, and switches SW1 to SW3 that switch a power transmission path. The booster circuit 221 can transmit, to the battery 4, a voltage of DC power boosted by performing a switching operation for voltage boosting. The pass-through circuit 222 transmits non-boosted DC power to the battery 4 by bypassing the booster circuit 221. The expression “non-boosted” means that voltage boosting is not performed by the booster circuit 221. As the switches SW1 to SW3, relays or the like are used.

The non-boosted DC power is not limited to being transmitted to the battery 4 via the pass-through circuit 222. For example, the non-boosted DC power can be transmitted to the battery 4 via the booster circuit 221 by the booster circuit 221 being deactivated.

The booster circuit 221 includes coils (inductors) L1 to L3 that store energy, and switching elements Q1 to Q6 that switch a current path for applying a voltage to the coils L1 to L3. By the switching elements Q1 to Q6 performing the switching operation for voltage boosting, the voltage between input terminals t1 and t2 can be boosted and output to output terminals t11 and t12. At the time of voltage boosting, some of the coils L1 to L3 and the switching elements Q1 to Q6 may be used, or all of these may be used with appropriate switching. Control on the switching elements Q1 to Q6 to realize voltage boosting may be performed by the charging controller 43 or another controller.

The switching elements Q1 to Q6 of the inverter 5 and the coils L1 to L3 of the electric motor 3 are diverted to elements of the booster circuit 221 of this embodiment. However, the booster circuit 221 may be a circuit having dedicated elements.

The charging circuit 22 further includes a first voltage sensor 224 that detects the voltage of the DC power that is supplied to the charging port 21 and a second voltage sensor 225 that detects the voltage of the battery 4. These detected values are transmitted to the charging controller 43. The voltage detected by the first voltage sensor 224 and the voltage detected by the second voltage sensor 225 may be referred to as an input voltage and an output voltage of the booster circuit 221.

The interface 41 is, as an example, composed of operation buttons of an operation panel at the driver’s seat combined with a display of the operation panel. The charging controller 43 can present information to the user by controlling indications on the display. The charging controller 43 can receive information from the user through operation signals of the operation buttons. The interface 41 is not limited to the above configuration, but may be configured, for example, to output and input information via a user’s mobile terminal. In this case, the interface 41 may be a communication module communicable with the mobile terminal.

The charging controller 43 stores several parameters 431 related to charging in a storage 43a (illustrated in FIG. 1). The parameters 431 include parameters set by the user including a charging end SOC of the battery 4. The charging end SOC is set to stop charging before reaching a full charge in order to, for example, reduce deterioration of the battery 4. As the charging end SOC, an SOC lower than the full charge of 100% is set, for example, 90%, 80% or 70%. The user can change the setting of the charging end SOC via the interface 41. Hereinafter, a case where 80% is set as the charging end SOC will be described.

The charging controller 43 is an ECU that operates by executing a control program stored in the storage 43a. The charging controller 43 controls the charging circuit 22, exchanges information with the user via the interface 41, and communicates with the charging facility(ies) 100. The charging controller 43 may be divided into ECUs, and the ECUs may be configured to operate in association with one another through communication. The charging controller 43 may be integrated with another ECU(s), such as the vehicle controller 7.

### Charging Control Process of First Embodiment

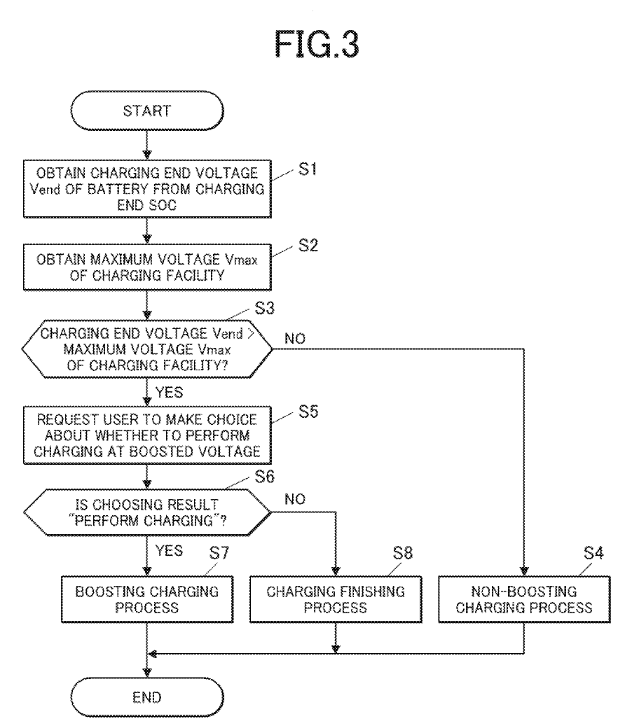

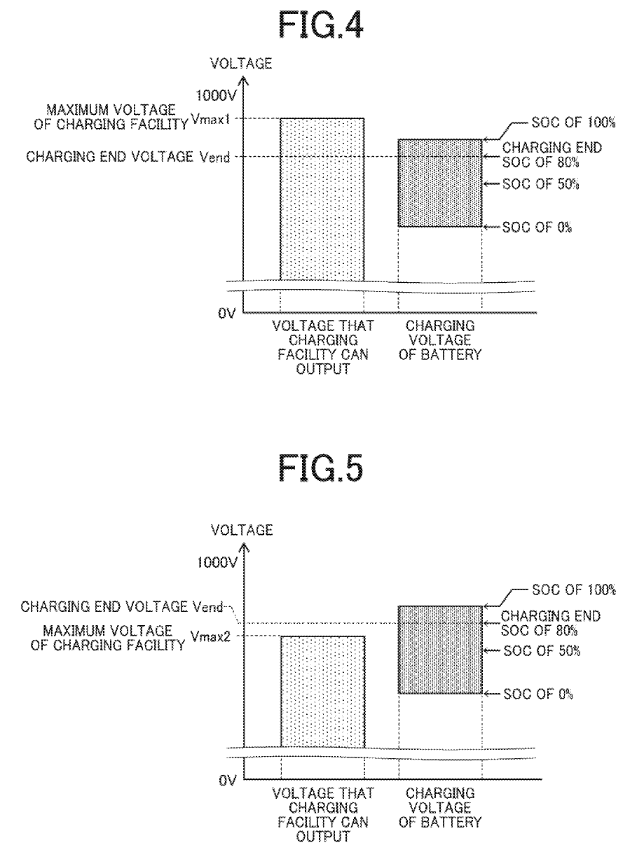

FIG. 3 is a flowchart illustrating a procedure for a charging control process of a first embodiment, the charging control process being performed by the charging controller 43. FIG. 4 is a graph of a first example illustrating a relationship between the voltage of the DC power that the charging facility 100 can output and the charging voltage of the battery 4. FIG. 5 is a graph of a second example illustrating a relationship between the voltage of DC power that another charging facility 100 can output and the charging voltage of the battery 4.

The charging control process is started by the charging controller 43 when the user attempts to charge the battery 4 at the charging facility 100, for example, when the charging connector 112 of the charging facility 100 is coupled to the charging port 21 of the electric vehicle 1.

When the charging control process is started, the charging controller 43 first obtains the charging end voltage Vend of the battery 4 (Step S1). The charging end voltage Vend means the charging voltage at the end of charging in a case where the battery 4 is charged to a preset charging end SOC. As illustrated by the charging voltage of the battery 4 in FIG. 4 and FIG. 5, the higher the SOC, the higher the charging voltage. The SOC and the open voltage of the battery 4 are correlated with one another, and the charging controller 43 can obtain, on the basis of the correlation, the charging end voltage Vend corresponding to the charging end SOC. It is assumed in this embodiment that the charging end SOC is set to 80%. In this case, the charging end voltage Vend is the charging voltage corresponding to the SOC of 80%.

Next, the charging controller 43 obtains the maximum voltage Vmax of the DC power of the charging facility 100 on the basis of the communication with the charging facility 100 (Step S2). The maximum voltage Vmax means the maximum voltage of the DC power that the charging facility 100 can output. As illustrated in FIG. 4, the maximum value of the voltage of the DC power that a certain charging facility 100 can output may be a high maximum voltage Vmax1. As illustrated in FIG. 5, the maximum value of the voltage of the DC power that another charging facility 100 can output may be a low maximum voltage Vmax2. Thus, the maximum voltage Vmax may vary depending on the charging facility 100.

Next, the charging controller 43 compares the charging end voltage Vend with the maximum voltage Vmax of the DC power (Step S3). In the case of the charging facility 100 in FIG. 4, the maximum voltage Vmax1 is equal to or higher than the charging end voltage Vend, whereas in the case of the other charging facility 100 in FIG. 5, the maximum voltage Vmax2 is lower than the charging end voltage Vend.

As a result of the comparison in Step S3, if the charging end voltage Vend is equal to or lower than the maximum voltage Vmax (i.e., Vend ≤ Vmax), the charging controller 43 performs a process of charging the battery 4 with non-boosted DC power (non-boosting charging process) (Step S4). In Step S4, the DC power is supplied directly from the charging facility 100 to the battery 4, and the battery 4 is rapidly charged, for example. As the SOC increases, the voltage of the DC power and the voltage of the battery 4 increase, and at the end of charging, the voltage reaches the charging end voltage Vend. When charging ends, the charging controller 43 performs a process of finishing charging (charging finishing process), and the charging control process ends.

On the other hand, as a result of the comparison in Step S3, if the charging end voltage Vend is higher than the maximum voltage Vmax (i.e., Vend > Vmax), the charging controller 43 allows the user to make a choice via the interface 41 about whether to perform charging at a boosted voltage (Step S5).

Then, the charging controller 43 determines the choosing result in Step S5 (Step S6). If the charging result is to perform charging, the charging controller 43 performs a process of charging the battery 4 with DC power boosted by the booster circuit 221 (boosting charging process) (Step S7). In Step S7, the DC power that the charging facility 100 outputs is adjusted to a low voltage, the power that is transmitted therefrom is lower as compared with the power at the time of rapid charging, loss is caused by voltage boosting, and so forth, and accordingly the charging speed is lower as compared with the charging speed at the time of rapid charging. As the SOC increases, the charging voltage increases, and at the end of charging, the charging end voltage Vend of the battery 4 exceeds the maximum voltage Vmax of the charging facility 100. When charging ends, the charging controller 43 performs the process of finishing charging, and the charging control process ends.

If the choosing result is not to perform charging according to the determination result in Step S6, the charging controller 43 does not start charging but performs the process of finishing charging (Step S8). Then, the charging control process ends.

A program 432 for the charging control process of the first embodiment is stored in a non-transitory computer-readable storage medium, such as the storage 43a of the charging controller 43. The charging controller 43 may be configured to read a program stored in a portable, non-transitory computer-readable storage medium and execute the program. The portable, non-transitory computer-readable storage medium may store the program 432 for the charging control process described above.

As described above, according to the charging control apparatus 40 of this embodiment, when the charging end voltage Vend of the battery 4 is higher than the maximum voltage Vmax of the charging facility 100, the user is allowed to make a choice via the interface 41 about whether to charge the battery 4 at a boosted voltage. Therefore, the user can perform charging in various situations with suitable manners therefor, for example, by performing charging at a boosted voltage if it is urgent or by moving to another charging facility where voltage boosting is unneeded if it is not urgent.

Further, according to the charging control apparatus 40 of this embodiment, the user can set and change the charging end SOC of the battery 4. When the charging controller 43 determines whether voltage boosting is to be performed, the charging end voltage Vend corresponding to the charging end SOC set by the user is used. Thus, determination about whether voltage boosting is to be performed can be made in accordance with the setting made by the user.

Further, according to the charging control apparatus 40 of this embodiment, when the maximum voltage Vmax of the charging facility 100 is equal to or higher than the charging end voltage Vend of the battery 4, the battery 4 is charged with non-boosted DC power. On the other hand, when the charging end voltage Vend of the battery 4 is higher than the maximum voltage Vmax of the charging facility 100, and the user chooses to perform charging at a boosted voltage, the battery 4 is charged with boosted DC power. Thus, in a situation where the need for choice making is high, the user is requested to make a choice, whereas in a situation where the need for choice making is low, charging can be started without a user’s choice.

### Charging Control Process of Second Embodiment

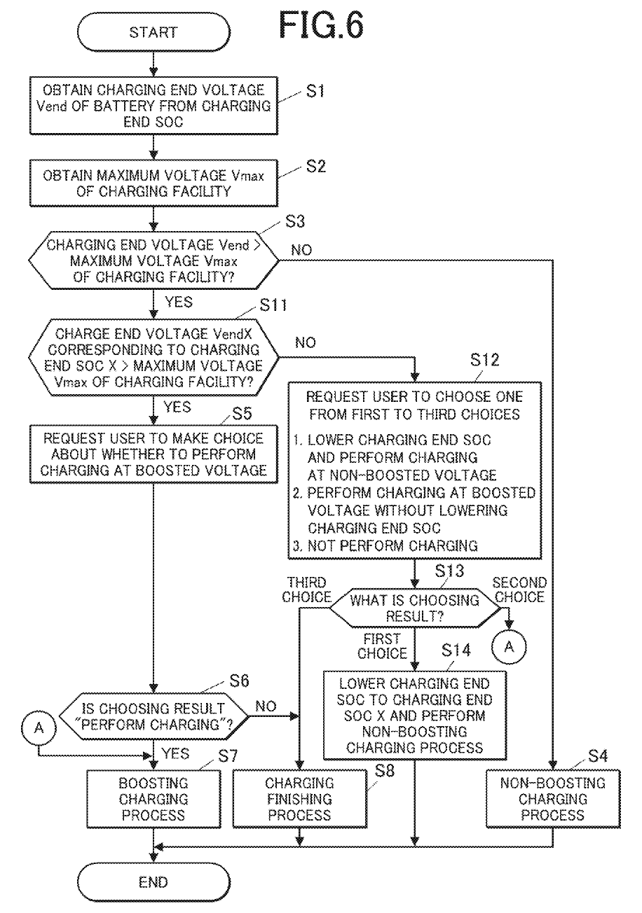

FIG. 6 is a flowchart illustrating a procedure for a charging control process of a second embodiment, the charging control process being performed by the charging controller 43. The charging control process of the second embodiment is the same as that of the first embodiment from the start to Step S4. In the second embodiment, if the result of the comparison in Step S3 is that the charging end voltage Vend is higher than the maximum voltage Vmax, the charging controller 43 performs the next comparison process (Step S11). That is, in Step S11, the charging controller 43 first assumes a case where the charging end SOC of the battery 4 has been lowered to a charging end SOC X, and obtains the charging end voltage VendX corresponding to the charging end SOC X. Then, the charging controller 43 compares this charging end voltage VendX with the maximum voltage Vmax of the charging facility 100. The charging end SOC X after lowered is set to a value higher than the SOC of the battery 4 at the point of time. The charging end SOC X may be a predetermined value (e.g., convenient value), such as N × 10% (where N is an integer of 5 to 9). As the charging end SOC X after lowered, one SOC may be used, or two or more SOCs, for example, 50% and 70%, may be used.

If the comparison result in Step S11 is that the charging end voltage VendX is higher than the maximum voltage Vmax (i.e., VendX > Vmax), the charging controller 43 performs processes in Steps S5 to S8. The processes in Steps S5 to S8 are the same as those of the charging control process of the first embodiment.

If the comparison result in Step S11 is that the charging end voltage VendX is equal to or lower than the maximum voltage Vmax (i.e., VendX ≤ Vmax), the charging controller 43 allows the user to perform the next choice making via the interface 41 (Step S12). In other words, the charging controller 43 allows the user to choose one from the following choices: to lower the charging end SOC to the SOC X and perform charging with non-boosted DC power (which is hereinafter referred to as a “first choice”); to perform charging at a voltage boosted by the booster circuit 221 without lowering the charging end SOC to the SOC X (which is hereinafter referred to as a “second choice”); and not to perform charging (which is hereinafter referred to as a “third choice”).

Then, the charging controller 43 determines the choosing result (Step S13). If the choosing result is the second choice, the charging controller 43 performs the boosting charging process in Step S7, whereas if the choosing result is the third choice, the charging controller 43 performs the finishing charging process in Step S8. Meanwhile, if the charging result is the first choice, the charging controller 43 lowers the charging end SOC to the SOC X and performs the process of charging the battery 4 with non-boosted DC power (Step S14). In Step S14, the DC power is supplied directly from the charging facility 100 to the battery 4, and the battery 4 is rapidly charged, for example. As the SOC increases, the voltage of the DC power and the voltage of the battery 4 increase, and at the end of charging, the voltage reaches the charging end voltage VendX corresponding to the SOC X and is equal to or lower than the maximum voltage Vmax of the DC power of the charging facility 100. When charging ends, the charging controller 43 performs the process of finishing charging, and the charging control process ends.

A program 432 for the charging control process of the second embodiment is stored in a non-transitory computer-readable storage medium, such as the storage 43a of the charging controller 43. The charging controller 43 may be configured to read a program stored in a portable, non-transitory computer-readable storage medium and execute the program. The portable, non-transitory computer-readable storage medium may store the program 432 for the charging control process described above.

As described above, according to the charging control apparatus 40 of the second embodiment, the effects same as those of the first embodiment are obtained. Further, according to the second embodiment, when the charging end charging voltage VendX of the battery 4 becomes equal to or lower than the maximum voltage Vmax of the charging facility 100 by the charging end SOC being changed to be lower, the charging controller 43 requests the user to make a choice about whether to lower the charging end SOC and perform charging with non-boosted DC power. Therefore, the user can perform charging in various situations, which include the situation where the charging end SOC may be lowered, with suitable manners therefor.

In the above, some embodiments of the disclosure have been described. However, the disclosure is not limited to the above embodiments. For example, the above embodiments illustrate the configuration in which the charging end SOC can be set by the user. However, the charging end SOC may be fixed. Further, in the above embodiments, the process of allowing the user to choose a charging mode (Step S5 in FIG. 3, Step S12 in FIG. 6, etc.) is performed after the charging connector 112 is coupled to the charging port 21. However, even before the charging connector 112 is coupled to the charging port 21, if the charging facility 100 and the charging controller 43 are communicable with one another and it is presumed that charging at the charging facility 100 is scheduled, the process of allowing the user to choose a charging mode may be performed. Besides, the details described in the embodiments can be changed as appropriate without departing from the scope of the disclosure.

1. A charging control apparatus of an electric vehicle that comprises a battery configured to store electric power for travel, a charging port configured to take in direct current power for charging from an external charging facility, and a charging circuit configured to charge the battery with the direct current power taken in via the charging port, the charging control apparatus comprising:
an interface configured to exchange information with a user; and
a charging controller configured to control charging,
wherein the charging circuit comprises a booster circuit configured to boost a voltage of the direct current power, and
wherein when a charging end voltage of the battery is higher than a maximum voltage of the direct current power that the charging facility is capable of outputting, the charging controller allows the user to make a choice via the interface about whether to charge the battery at a boosted voltage boosted by the booster circuit.

2. The charging control apparatus of the electric vehicle according to claim 1,
wherein an item settable by the user via the interface includes a setting item of a charging end state of charge of the battery, and
wherein the charging end voltage is a voltage corresponding to the charging end state of charge.

3. The charging control apparatus of the electric vehicle according to claim 1, wherein the charging controller
charges the battery at a voltage not boosted by the booster circuit when the charging end voltage is equal to or lower than the maximum voltage, and
charges the battery at the boosted voltage boosted by the booster circuit when the charging end voltage is higher than the maximum voltage and the choice made is to charge the battery.

4. The charging control apparatus of the electric vehicle according to claim 2, wherein when the charging end voltage becomes equal to or lower than the maximum voltage by the charging end state of charge being changed to be lower, the charging controller allows the user to choose at least between (i) changing the charging end state of charge and charging the battery at a voltage not boosted by the booster circuit and (ii) charging the battery at the boosted voltage boosted by the booster circuit without changing the charging end state of charge.
